(19) United States
(12) Patent Application Publication
(10) Pub. No.: US 2015/0217577 A1
(43) Pub. Date: Aug. 6, 2015

(54) SYSTEMS AND METHODS FOR PRINTING ON A SUBSTRATE

(71) Applicant: FUNAI ELECTRIC CO., LTD., Daito-shi, Osaka (JP)

(72) Inventors: Robert Wilson Cornell, Lexington, KY (US); Chad Young, Lexington, KY (US); Jancy Bonewits, Lexington, KY (US)

(73) Assignee: FUNAI ELECTRIC CO., LTD., Daito-shi, Osaka (JP)

(21) Appl. No.: 14/426,491

(22) PCT Filed: Sep. 9, 2013
(86) PCT No.: PCT/IB2013/002671

§ 371 Date: Mar. 6, 2015

Related U.S. Application Data
(60) Provisional application No. 61/697,966, filed on Sep. 7, 2012.

(51) Int. Cl. B41J 11/00

(52) U.S. Cl. CPC B41J 11/002

(57) ABSTRACT

A printing system including a printing device operable for applying one or more inks onto a substrate, and a heating device operable for heating the substrate prior to application of the one or more inks onto the substrate.

### FIELD

The present invention relates to systems and methods for printing one or more inks applied to a substrate.

### BACKGROUND

Conventional inkjet print systems are now able to provide a throughput of 20 pages per minute (ppm). Unfortunately, one of the problems uncovered during the test phase of these systems was smear and offset due to incomplete drying. At 20 ppm, there simply is not enough time to dry a printed page before the next one comes along. To deal with this problem, new color tables were created that limited the solid-fill ink coverage per unit area to 80%.

While drastically improving the smear issue, reducing the ink coverage has a negative side effect in lower optical density and contrast. With reduced ink coverage, the images produced are noticeably lighter than the images produced with 100% coverage color tables.

Previous systems that were limited to 12 ppm did not suffer with this smear issue on the same paper set. Thus, it would seem that 20 ppm is at the threshold of where dry time kinetics must be engineered into the print system. Certainly, as print speeds are increased to much greater than 20 ppm, an engineered approach to dry time kinetics is demanded because ink coverage can not be continuously scaled back. Additionally, while dry time issues may be addressed with ink formulation changes, it is highly unlikely that a faster penetrating ink can be formulated without having increased feathering and reduced optical density. Even with new ink formulations, a special paper is required in order to avoid the low print quality that would otherwise occur.

Therefore, an object of the present invention is to provide a means of improving inkjet dry time kinetics that does not degrade print quality or optical density, and which applies across a range of paper types.

Another object of the present invention is to address the need for high print quality at throughputs well beyond the 12-20 ppm of today and to the 60+ ppm of the future.

### SUMMARY OF THE INVENTION

A printing system according to an exemplary embodiment of the present invention comprises: a printing device operable for applying one or more inks onto a substrate; and a heating device operable for heating the substrate prior to application of the one or more inks onto the substrate.

In at least one exemplary embodiment, the heating device comprises a heated roller that contacts the substrate.

In at least one exemplary embodiment, the heating device comprises a drive belt that forms a nip with the heated roller.

In at least one exemplary embodiment, an outer diameter of the heated roller is within a range of 20 mm to 40 mm.

In at least one exemplary embodiment, the heated roller comprises an outer wall and a first coating disposed on an outer surface of the outer wall.

In at least one exemplary embodiment, the heated roller comprises a second coating disposed on an inner surface of the outer wall.

In at least one exemplary embodiment, the second coating is made of black anodized aluminum.

In at least one exemplary embodiment, a thickness of the outer wall of the heated roller is within a range of 0.5 mm to 1.5 mm.

In at least one exemplary embodiment, a thickness of the first coating is about 25 μm.

In at least one exemplary embodiment, the first coating is made of polytetrafluoroethylene.

In at least one exemplary embodiment, a thickness of the drive belt is about 127 μm.

In at least one exemplary embodiment, the drive belt is made of a polyimide film.

In at least one exemplary embodiment, the polyimide film is poly(4,4′-oxydiphenylene-pyromellitimide).

In at least one exemplary embodiment, a wrap angle at the nip is within a range of 2° to 80°.

In at least one exemplary embodiment, a thruput of the printing device is within a range of 30 ppm to 60 ppm.

In at least one exemplary embodiment, the heated roller comprises a bulb that generates thermal energy to heat the substrate.

In at least one exemplary embodiment, a maximum input power of the bulb is within a range of 350 W to 800 W.

Other features and advantages of embodiments of the invention will become readily apparent from the following detailed description, the accompanying drawings and the appended claims.

### BRIEF DESCRIPTION OF THE DRAWINGS

The features and advantages of exemplary embodiments of the present invention will be more fully understood with reference to the following, detailed description when taken in conjunction with the accompanying figures, wherein:

FIG. 1 is plot of absorption volume per unit area versus the square root of time for a conventional paper-ink pair;

FIGS. 2A-2D are plots of absorption rate/evaporation rate versus relative humidity at various temperatures for different values of absorption coefficient;

FIG. 3 is a plot of functional dry time versus ink coverage and absorption coefficient;

FIG. 4 is a plot of absorption coefficient multiplier as a function of ink-media temperature for two inks of interest: Mono-1 and Magenta-1;

FIG. 5 is a schematic diagram of a printing system, generally designated by reference number 10, according to an exemplary embodiment of the present invention; and

FIG. 6 is a schematic diagram of the heating device according to an exemplary embodiment of the present invention.

### DETAILED DESCRIPTION

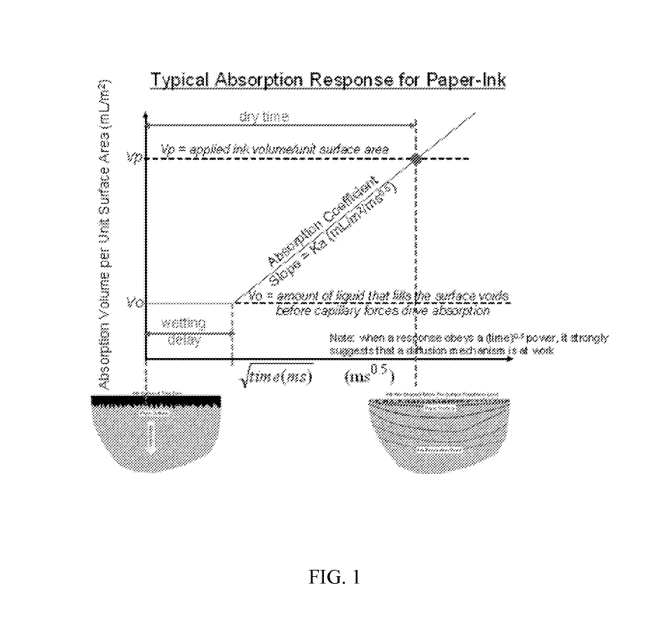

The relative effect of absorption verses evaporation of an ink-media pair depends upon the absorption coefficient (Ka). In this regard, the Bristow test is well-known in the industry as a means of determining the value of Ka for any given ink-media pair. When absorption volume per unit area is plotted versus the square root of time, the Bristow test results have a characteristic response like that shown in FIG. 1. The absorption coefficient (Ka) is the slope of the line and has units of (milli-Liters/meter²/milli-seconds^{0.5}).

As expected, when Ka is large, absorption into the media occurs quickly. However, if the ink-media pair is too absorbent, the printed edges will appear ragged and fuzzy. It has been found that print quality (PQ) scores are correlated to Ka. In particular, ink-paper pairs having a Ka value greater than 0.25 will not produce acceptable print quality.

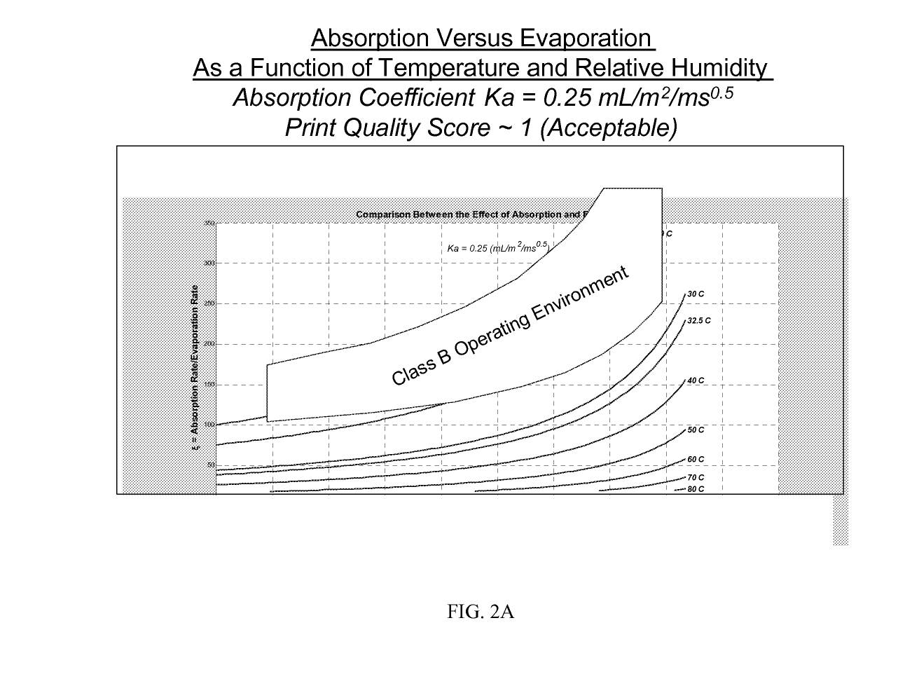

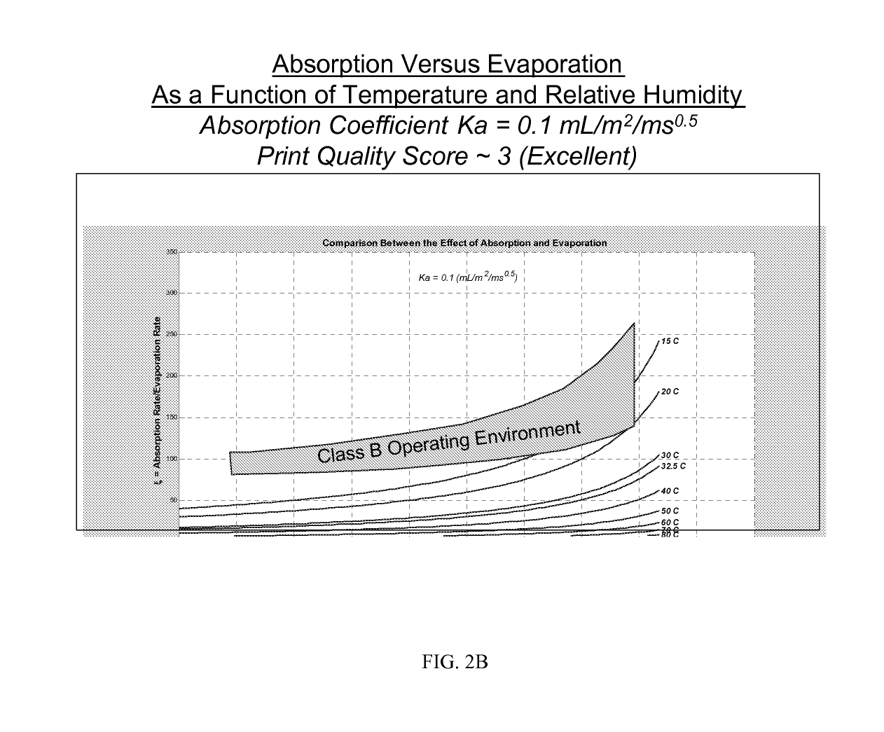

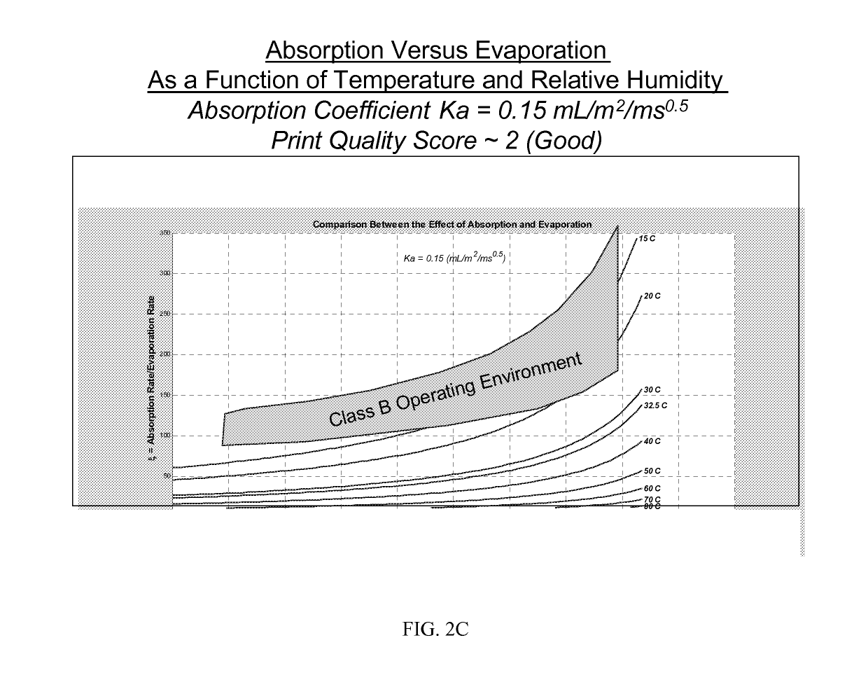

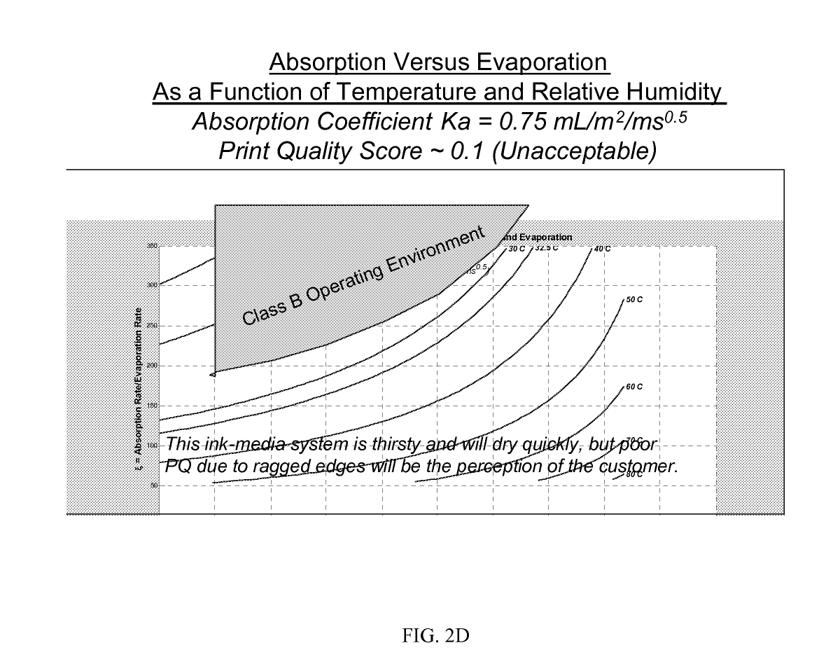

FIGS. 2A-2D illustrate the relative contributions of absorption versus evaporation over a relevant range of Ka values and a range of ambient temperature—relative humidity conditions. In particular, FIG. 2A shows that an ink-media set with an absorption coefficient of 0.25 mL/m²/ms^{0.5} will have “Acceptable” print quality, and over the Class-B environmental range, absorption is 45-300+ times more effective than evaporation. FIG. 2B shows that an ink-media set with an absorption coefficient of 0.10 mL/m²/ms^{0.5} will have “Excellent” print quality, and over the Class-B environmental range, absorption is 20-200 times more effective than evaporation. FIG. 2C shows that an ink-media set with an absorption coefficient of 0.15 mL/m²/ms^{0.5} will have “Good” print quality, and over the Class-B environmental range, absorption is 25-300 times more effective than evaporation. FIG. 2D shows that an ink-media set with an absorption coefficient of 0.75 mL/m²/ms^{0.5} will have “Unacceptable” print quality, and over the Class-B environmental range, absorption is 125-350+ times more effective than evaporation. Thus, for a class B environment, over a large range of Ka values, the absorption effect is far greater than the evaporation effect.

It may be shown that the absorption coefficient (Ka) is a function of contact angle, surface tension and viscosity:

$$Absorption coefficient ≡ {K}_{a} ∝ ( \frac{σ cos θ}{μ} ) \\ σ ≡ surface tension \\ μ ≡ dynamic viscosity \\ θ ≡ contact angle \qquad ( 1 )$$

It is known that surface tension and viscosity are functions of ink temperature. In particular, it is known that the value for σ/μ increases with increasing temperature. Accordingly, exemplary embodiments of the present invention involve the impact of ink on a warm media, which greatly increases absorption, thereby addressing the smear problem without the need for kilowatt sized evaporative driers.

Conventionally, an entire print system needs to be built and go through several hardware iterations and dozens of firmware iterations before it is even possible to determine whether smear is, or is-not an issue. Having the capability of measuring Ka with an off-line test, combined with a mathematical model of the diffusion kinetics at the ink-media interface, provides the ability to predict functional dry time for any ink-media pair before design of a print system is even began. In particular, according to a method of designing a printing system according to an exemplary embodiment of the present invention, the absorption coefficient Ka may be measured in an off-line Bristow test for any given ink-media pair. Ka² is equal to the mass transport diffusivity of the ink-media pair. Since Ka is a function of surface tension (σ) and dynamic viscosity(μ), both of which are known functions of temperature, the mass transport diffusivity of the ink-media pair as a function of temperature can be estimated. This can be done in two ways: 1) if the Bristow tester is designed to have a paper warming capability, Ka versus temperature can be measured for any given ink-media pair; or 2) surface tension and viscosity can be measured over a range of temperatures to estimate the effect of Ka over a range of temperatures if a baseline value of Ka is measured at room temperature. Therefore, given an off-line measurement of Ka, well-known mathematical methods can be used to quantitatively predict the functional dry time of any ink-media pair. In particular, the following equation for diffusive mass transport (using (Ka)² in place of D) may be solved using, for example, finite element analysis, to determine values for functional dry time over a range of species concentration:

$$D ( \frac{{\partial }^{2} φ}{\partial {φ}^{2}} + \frac{{\partial }^{2} φ}{\partial {y}^{2}} + \frac{{\partial }^{2} φ}{\partial {z}^{2}} ) = \frac{\partial φ}{\partial t} = D {∇}^{2} φ \\ D = diffusion coeffient \\ φ = species concentration \\ t = time \qquad ( 2 )$$

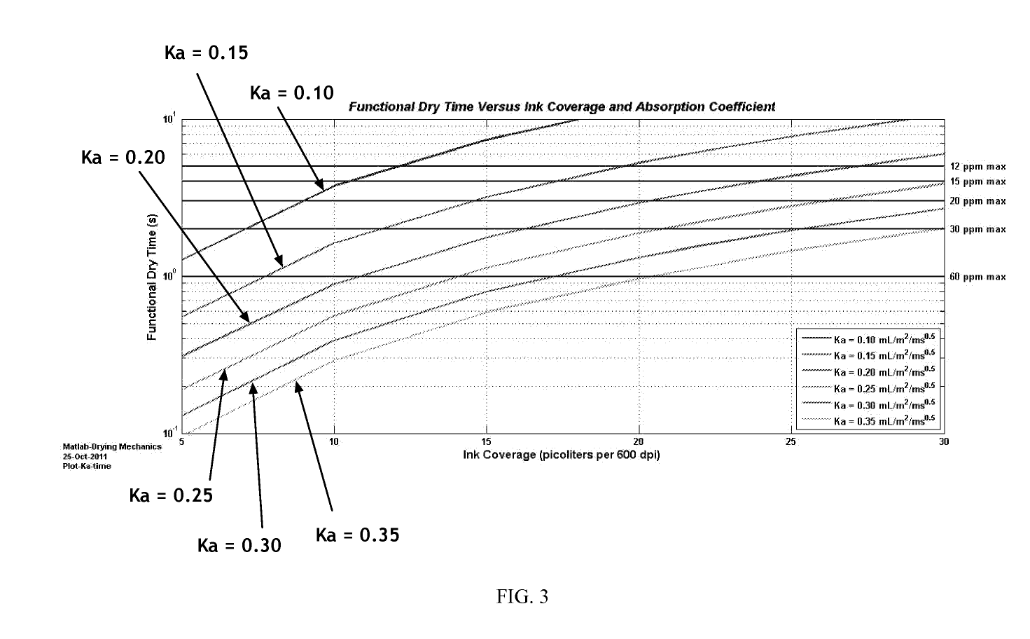

Using equation (2), a plot of functional dry time versus ink coverage and absorption coefficient may be generated, as shown in FIG. 3. From this plot, the absorption coefficient required to produce solid-fill, high optical density, mono-blocks at various print system throughput capabilities can be estimated. In this regard, Table 1 provides minimum required Ka values over a range of throughput capabilities to produce a solid fill at 20 pL/600 dpi.

TABLE 1

| PRINT SYSTEM | MINIMUM REQUIRED |
|---|---|
| CAPABILITY (PPM) | Ka VALUE (mL/m²/ms^{0.5}) |
| 12 | 0.15 |
| 15 | 0.17 |
| 20 | 0.20 |
| 30 | 0.25 |
| 60 | 0.35 |

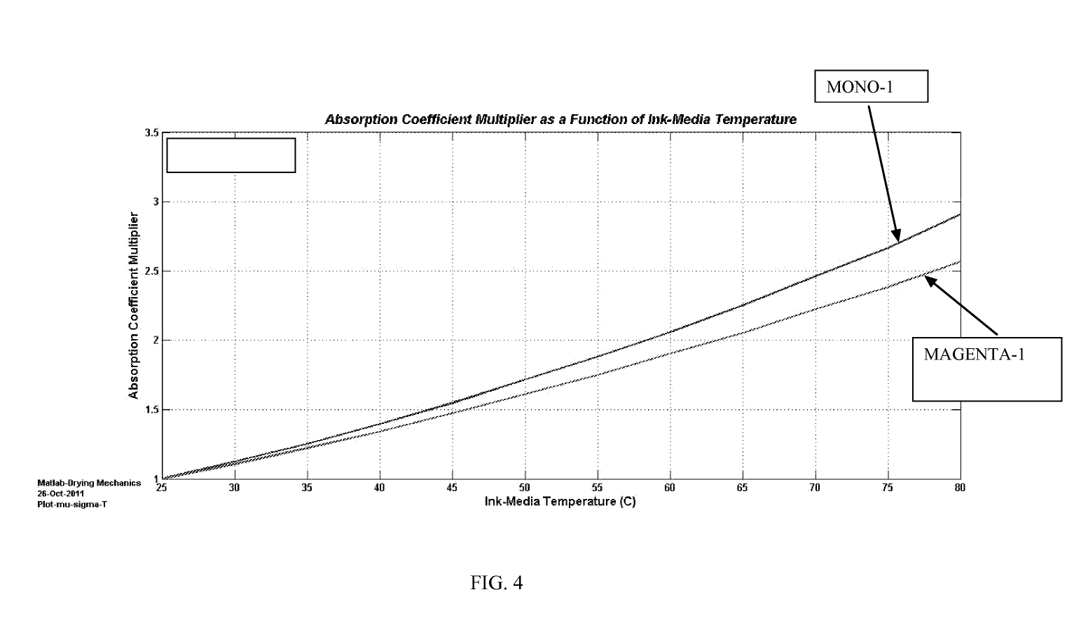

As discussed, the ratio of σ/μ is a function of temperature, and Ka is directly proportional to σ/μ. Therefore, the ink-media pair can be heated to increase the absorption coefficient. That is, according to various exemplary embodiments of the present invention, ink is jetted onto a warm substrate to enhance the absorption process. From Table 1, the Ka required to achieve smear-free (i.e. functionally dry) printing across a wide range of print system throughputs can be determined. For a given ink, the effect of temperature on σ/μ can be measured, which in turn may provide an absorption coefficient multiplier over a range of temperatures. For example, FIG. 4 provides a plot of absorption coefficient multiplier as a function of ink-media temperature for two inks of interest: Mono-1 and Magenta-1.

The following example illustrates a method of designing a printing system according to an exemplary embodiment of the present invention.

### EXAMPLE 1

An ink-media pair having a Ka value of 0.15 mL/m2/ms0.5 is provided. This Ka value is typical for an ink-media pair that produces very good print quality. According to Table 1, a Ka value of 0.15 can only support a print system having a thruput of 12 ppm when solid area fills contain the desired 20 pL/600 dpi. If a 20 ppm print system is required, the plot of FIG. 3 indicates that the ink coverage would need to be reduced to 15 pL/600 dpi to achieve functional dry-time in 3 seconds. In other words, to make this ink-media pair work in a smear-free fashion at 20 ppm or higher, the ink coverage would need to be reduced by at least ˜25%. However, instead of reducing ink coverage, which would degrade optical density and contrast, the absorption coefficient may be degraded by jetting onto a warm sheet of paper. In this example, the printing system requirements include a throughput of 60 ppm, a Ka value of 0.15 and a solid fill coverage at 20 pL/600 dpi. Table 1 indicates that Ka would need to be decreased to 0.35 mL/m²/ms^{0.5} based on these requirements. In other words, to achieve 60 ppm with this ink-media pair, the absorption coefficient must be increased from 0.15 to 0.35, so that a 2.3 multiplier is needed. For a 2.3 multiplier of absorption, FIG. 4 calls for heating the ink-media pair to ˜65-70 C.

According to various exemplary embodiments of the present invention, a heating device is provided within a printing system that heats the ink-media pair to enable a smear-free, high-speed print system solution without resorting to reduced ink coverage. In exemplary embodiments, the ink-media pair may be heated from ˜25° C. to ˜65° C. or higher, depending on the design requirements of the printing system.

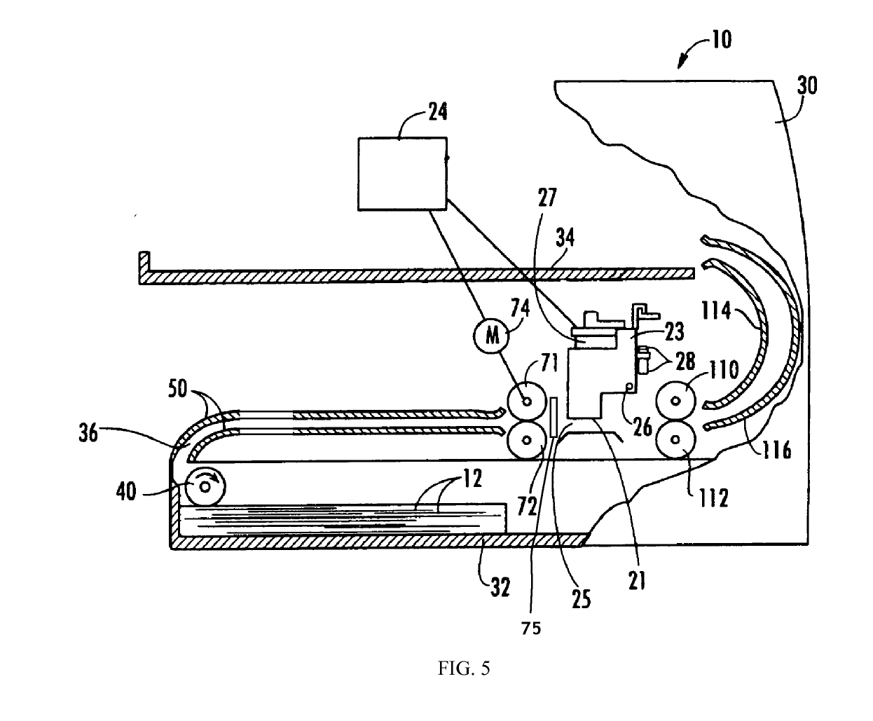

FIG. 5 is a schematic diagram of a printing system, generally designated by reference number 10, according to an exemplary embodiment of the present invention. The printing system 10 may be an inkjet printer that includes a print head 27, located about a print zone 25, such as within a printer housing 30. The print head 27 includes an ejector chip 21 comprising actuators associated with a plurality of discharge nozzles (not shown). An ink supply, such as an ink filled container, is in fluid communication with the ejector chip 21 (in the illustrated embodiment, the ink supply is integrally formed with the print head 27). The print head 27 is supported in a carrier 23 which, in turn, is supported on a guide rail 26 of the printer housing 30. A drive mechanism, such as a drive belt 28 is provided for effecting reciprocating movement of the carrier 23 and the print head 27 back and forth along the guide rail 26. As the print head 27 moves back and forth, it ejects ink droplets 14 via the ejector chip 21 onto a substrate 12 that is provided below it along a substrate feed path 36, to form a swath of information (typically having a width equal to the length of a column of discharges nozzles). As used throughout this description, the term “ink” is intended to include any aqueous or nonaqueous-based substance suitable for forming an image (or component thereof) on a substrate when deposited thereon.

A driver circuit 24 may provide voltage pulses to the actuators, such as resistive heating elements or piezoelectric elements (not shown) located in the ejector chip 21. In the case of resistive heating elements, each voltage pulse is applied to one of the heater elements to momentarily vaporize ink in contact with that heating element to form a bubble within a bubble chamber (not shown) in which the heating element is located. The function of the bubble is to displace ink within the bubble chamber such that a droplet of ink are expelled from at least one of the discharge nozzles associated with the bubble chamber.

The printer housing 30 may include a tray 32 for storing substrates 12 to be printed upon. A rotatable feed roller 40 may be mounted within the housing 30 and positioned over the tray 32. Upon being rotated by a conventional drive device (not shown), the roller 40 grips the uppermost substrate 12 and feeds it along an initial portion of the substrate feed path 36. The feed path 36 portion is defined in substantial part by a pair of substrate guides 50. A coating apparatus (not shown) may optionally be used to apply a layer of coating material onto at least a portion of a first side of the substrate 12 prior to printing, such as to facilitate better print quality.

A pair of first feed rollers 71 and 72 may be positioned within the housing 30. The feed rollers 71 and 72 may be incrementally driven by a conventional roller drive device 74 that may also be controlled by the driver circuit 24. The first feed rollers 71 and 72 incrementally feed the substrate 12 into the print zone 25 and beneath the print head 27. As noted above, the print head 27 ejects ink droplets 14 onto the substrate 12 as it moves back and forth along the guide rail 26 such that an image is printed on the substrate 12.

A pair of second feed rollers 110 and 112 may be positioned within housing 30 downstream from the print head 27. The second feed rollers 110 and 112 may be incrementally driven by a conventional roller drive device (not shown) that may be controlled by the driver circuit 24. The feed rollers 110 and 112 cause the printed substrate 12 to move through final substrate guides 114 and 116 to an output tray 34.

A heating device 75 may be positioned within the housing 30 between the first feed rollers 71 and 72 and the print zone 25. The heating device may be operable for heating the substrate prior to application of the one or more inks onto the substrate to reduce or eliminate smear, particularly in the case of a high-speed print system (e.g., a printing system with a throughput of 12 ppm or higher). In this regard, the heating device may heat the substrate prior to transport into the print zone from an ambient temperature (e.g., approximately 25° C.) to a higher temperature, for example up to a temperature within a range of 50° C. to 80° C. Heating of the substrate may be controlled by the drive circuit 24 by maintaining the heating device 75 at a temperature required to warm the substrate to a temperature that results in increased Ka of the ink-substrate pair.

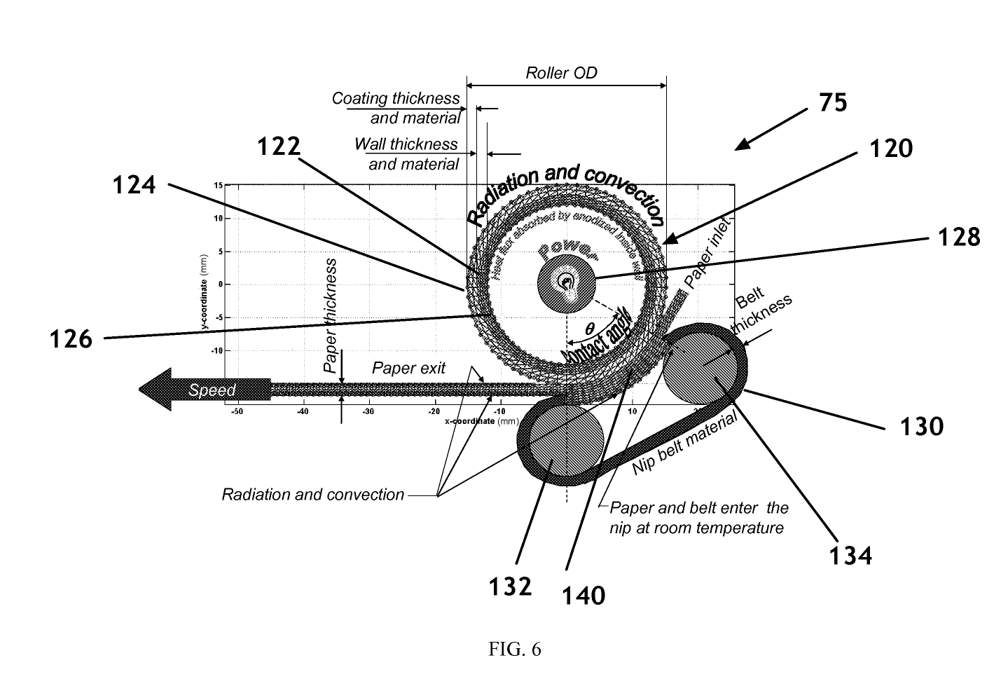

FIG. 6 is a schematic diagram of the heating device 75 according to an exemplary embodiment of the present invention. The heating device includes a heated roller 120 and a drive belt 130. A nip 140 is formed between the heated roller 120 and the drive belt 130. The nip contact angle may be, for example, within a range of 2° to 80°.

The heated roller 120 includes an outer wall 122, a first coating 124 disposed on the outer surface of the outer wall 122, and an inner coating 126 disposed on the inner surface of the outer wall 122. The outer diameter of the heated roller 120 may be within a range of, for example, 20 mm to 40 mm. The outer wall 122 may be made of aluminum and have a thickness within a range of, for example, 0.5 mm to 1.5 mm. The first coating 124 may be made of, for example, polytetrafluoroethylene and may have a thickness of, for example, 25 gm. The second coating is intended for absorption of heat flux generated by a heating element disposed within the heated roller 120 and may be made of, for example, black anodized aluminum.

The heating element may be, for example, a bulb 128. The maximum input power to the bulb 128 may be within a range of, for example, 350 W to 800 W. The bulb 128 may be controlled so as to maintain the surface of the heated roller as a temperature within a range of, for example, 100 C to 180 C, depending on the required Ka of the ink-substrate pair. In this regard, maximum input power may be used during warm-up of the printing device, and then as the substrate begin to move through the nip 140, the power may be modulated to maintain the desired roller temperature. For example, the average modulated power may be 70% of the peak power.

The drive belt 130 is driven by two drive rollers 130 and 132 to transport the substrate through the nip 140. The drive belt 130 may be made of a polyimide film, such as, for example, poly(4,4′-oxydiphenylene-pyromellitimide) and have a thickness of 127 μm.

The following examples illustrate a heating device according to an exemplary embodiment of the present invention.

### EXAMPLE 2

A heating device is provided having the same general structure as that shown in FIG. 6. The heating device has the following characteristics:

outside diameter of heated roller=30 mm

heated roller wall is 1.0 mm thick aluminum

outer coating is 25.4 μm thick Teflon®

nip belt is 5 mil thick Kapton®

nip contact angle=60°

throughput=30 ppm (5.75 in/s)

heated roller surface control temperature=130° C.

heated roller warm-up time=11.7 s

average media temperature at nip exit=77° C.

media temperature 45 mm past nip=73° C.

maximum bulb power=550 W

average power at 30 ppm=395 W.

### EXAMPLE 3

A heating device is provided having the same general structure as that shown in FIG. 6. The heating device has the following characteristics:

outside diameter of heated roller=40 mm

heated roller wall is 1.0 mm thick aluminum

outer coating is 25.4 μm thick Teflon®

nip belt is 5 mil thick Kapton®

nip contact angle=55°

throughput=30 ppm (5.75 in/s)

heated roller surface control temperature=115° C.

heated roller warm-up time=10 s

average media temperature at nip exit=70° C.

media temperature 45 mm past nip=68° C.

maximum bulb power=737 W

average power @ 30 ppm=360 W

While particular embodiments of the invention have been illustrated and described, it would be obvious to those skilled in the art that various other changes and modifications may be made without departing from the spirit and scope of the invention. It is therefore intended to cover in the appended claims all such changes and modifications that are within the scope of this invention.

What is claimed is:

1. A printing system, comprising:
a printing device operable for applying one or more inks onto a substrate; and
a heating device operable for heating the substrate prior to application of the one or more inks onto the substrate.

2. The printing system of claim 1, wherein the heating device comprises a heated roller that contacts the substrate.

3. The printing system of claim 2, wherein the heating device comprises a drive belt that forms a nip with the heated roller.

4. The printing system of claim 2, wherein an outer diameter of the heated roller is within a range of 20 mm to 40 mm.

5. The printing system of claim 2, wherein the heated roller comprises an outer wall and a first coating disposed on an outer surface of the outer wall.

6. The printing system of claim 5, wherein the heated roller comprises a second coating disposed on an inner surface of the outer wall.

7. The printing system of claim 6, wherein the second coating is made of black anodized aluminum.

8. The printing system of claim 5, wherein a thickness of the outer wall of the heated roller is within a range of 0.5 mm to 1.5 mm.

9. The printing system of claim 5, wherein a thickness of the first coating is about 25 μm.

10. The printing system of claim 5, wherein the first coating is made of polytetrafluoroethylene.

11. The printing system of claim 3, wherein a thickness of the drive belt is about 127 μm.

12. The printing system of claim 3, wherein the drive belt is made of a polyimide film.

13. The printing system of claim 12, wherein the polyimide film is poly(4,4′-oxydiphenylene-pyromellitimide).

14. The printing system of claim 3, wherein a wrap angle at the nip is within a range of 2° to 80°.

15. The printing system of claim 1, wherein a throughput of the printing device is within a range of 30 ppm to 60 ppm.

16. The printing system of claim 1, wherein the heated roller comprises a bulb that generates thermal energy to heat the substrate.

17. The printing system of claim 16, wherein a maximum input power of the bulb is within a range of 350 W to 800 W.
